(19) United States
(12) Patent Application Publication
(10) Pub. No.: US 2005/0179387 A1
(43) Pub. Date: Aug. 18, 2005

(54) Lamp and method for producing a lamp

(76) Inventor: Marten Willem Schuiteman, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/507,811

(22) PCT Filed: Feb. 17, 2003
(86) PCT No.: PCT/IB03/00639

(30) Foreign Application Priority Data
Mar. 18, 2002 (EP) 02076068.2

(51) Int. Cl. H01J 17/18; H01J 61/36; H01J 9/00

(52) U.S. Cl. 313/623; 313/624; 313/625; 445/26

(57) ABSTRACT

A lamp, such as a incandescant filament (halogen) or a discharge lamp, comprising a lamp vessel (1) of quartz glass and having a room filled with gas, two electrodes (5) extending into said room, two external current conductors (6) partially extending outside said vessel (1), two metal foils (4) embedded in said quartz glass, wherein a first end portion of a metal foil (4) is connected to an electrode (5) and wherein a second end portion of a metal foil (4) is connected to an external current conductor (6), and wherein an end portion (8) of said external conductor (6) which is connected to said metal foil (4) has a substantially circular cross section having a surface area which is smaller than the cross section of the portion of said external current conductor (6) extending outside the vessel (1).

The invention relates to a lamp, such as a incandescant filament (halogen) or a discharge lamp, comprising a lamp vessel of quartz glass and having a room filled with a gas filling, two electrodes extending into said room, two external current conductors partially extending outside said vessel, two metal foils embedded in said quartz glass, wherein a first end portion of a metal foil is connected to an electrode and wherein a second end portion of said metal foil is connected to an external current conductor.

Such an lamp is known from EP 0 579 313. A body in the shape of a foil is used in lamps having a lamp vessel of quartz glass, i.e. glass having an SiO₂ content of at least 96% by weight, for obtaining a vacuum tight seal on a metal body having a strongly different coefficient of linear thermal expansion, 54*10⁻⁷ and 45*10⁻⁷ for molybdenum and tungsten, respectively, as compared with approximately 6*10⁻⁷ for quartz glass. Depending on its width, the foil is thin, for example, approximately a hundred μm for a width of 1 cm, to very thin, for example, a few tens of μm, for example, 30 μm for a width of, for example, 2 mm. The small thickness renders the foil mechanically vulnerable. The external and the internal current conductors are much thicker for providing a sufficient conductance and a sufficient mechanical strength.

The conductors are laterally connected to the metal foil with overlaps. When a metal foil with an external and an internal current conductor connected thereto is embedded in the wall of a lamp vessel, in a pinched seal or in a fused seal, the glass centres the current conductors in the said seal. The metal foil is also centred in a zone situated between the conductors. Preferably the metal foils and/or the external current conductors are substantially made of molybdenum and preferably the end portion of the metal foil connected to the external current conductor is provided with a chrome coating in the area surrounding the connection with the external current conductors, in order to protect them against oxidation by oxygen, which during use is leaking into the seal from the outside.

The current conductors and the foil are connected to each other for instance by resistance welding. However, due to the imbalance of the heat capacity between the external current conductor, having a relatively large mass, and the foil, having a relatively small mass, the energy needed for said welding is very high, whereby the temperature of the foil becomes very high, and which causes oxidation of the surface of the molybdenum foil. The oxidation layer formed on said surface has a negative impact on the subsequent deposition and adhesion of the chrome protection layer.

Also the relatively thick external current conductor shields off the foil, such that the chrome does not, at least not completely, deposit on the foil near the welding spot, which is the place where chrome protection of the foil is most needed. Furthermore the large mass of the external current conductor can prevent the temperature of the chrome to become sufficiently high to be liquified during said sealing action, whereby the chrome is not distributed completely on the surface.

It is an object of the invention to provide an electric lamp of the kind described in the opening paragraph which is readily manufactured and in which the risk of damage to the metal foil is counteracted. In particular it is an object of the invention to improve deposition of the chrome layer on the molybdenum foil.

According to the invention, this object is achieved in that an end portion of said external conductor which is connected to said metal foil has a substantially circular cross section having a surface area which is smaller than the cross section of the portion of said external current conductor extending outside the discharge vessel. By reducing the cross section, the mass imbalance between the conductor and the foil during welding and deposition of the chrome layer is improved, resulting in a better adhesion and distribution of the chrome, also in the area adjecent the welding spot.

Preferably the surface area of the cross section of said end portion of the external current conductor is equal to or less than 0.80 times, more preferably equal to or less than 0.50 times, still more preferably equal to or less than 0.33 times the surface area of the cross section of said portion of the external current conductor extending outside the discharge vessel.

Preferably the surface area of the cross section of said end portion of the external current conductor is less than 0.7 mm, more preferably equal to or less than 0.5 mm, still more preferably equal to or less than 0.4 mm.

Preferably the length of the end portion having a reduced cross section is at least 2 mm, more preferably at least 4 mm.

The reduced diameter of the end portion can be achieved by mechanical grinding, elongation, forging or rolling.

The invention also relates to a method for producing a lamp, wherein two electrodes are connected to two external current conductors by means of a metal foil, wherein a first end portion of said metal foil is connected to an electrode and wherein a second end portion of said metal foil is connected to an end portion of an external current conductor, wherein a vessel is made of quartz glass such that a room is formed which is filled with a gas filling, wherein said metal foils are embedded in said quartz glass, wherein said electrodes are extending into said room, and said external current conductors are partially extending outside said vessel, and wherein said end portion of said external current conductor destined to be connected to said metal foil is provided with a substantially circular cross section having a surface area which is smaller than the cross section of the portion of the external current conductor destined to extend ouside the vessel.

It is noted that the invention relates to an embodiment wherein the two electrodes extending into the room are interconnected by an incandescent filament (halogen lamp), as well as to an embodiment wherein the two electrodes extending into the room ionize an ionizable filling present in said room and maintain a discharge between said electrodes.

An embodiment of the electric lamp according to the invention is shown in the drawing, in which

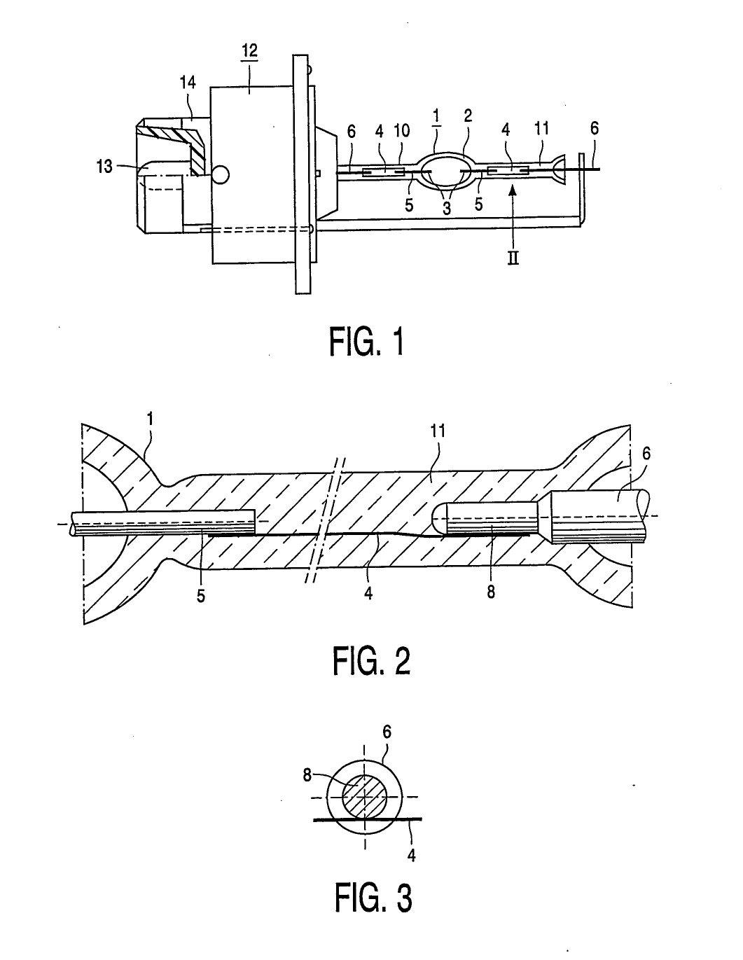

FIG. 1 shows a discharge lamp in side elevation;

FIG. 2 shows a detail of FIG. 1 on an enlarged scale; and

FIG. 3 shows a cross section of an external conductor connected to a metal foil.

The electric lamp of FIG. 1 has a lamp vessel 1 which is closed in a vacuumtight manner and which has a quartz glass wall 2 and an electric element 3, and a filling inside. Metal foils 4 are embedded in the lamp vessel wall and connected to respective internal current conductors 5 extending to the electric element and to respective external current conductors 6 made of molybdenum. The lamp shown is an electric discharge lamp in which the free end portions of the internal current conductors 5 form the electric element 3, i.e. tungsten electrodes. The lamp vessel has a filling of mercury, sodium iodide and scandium iodide, and xenon, for example, with a pressure of 7 bar at room temperature.

The external current conductors 6 extend from the wall 2 to the exterior, and the relevant metal foil 4 is welded to the end portion 8 (see FIG. 2) of external current conductor 6.

The end portion 8 of each external current conductor 6 is given a smaller diameter than the outwardly extending portion of said conductor 6. The main diameter of conductor 6 may for instance be 0.7 mm, while end portion 8 is given a diameter of 0.4 mm.

In the electric lamp shown, the metal foils, made of molybdenum, are embedded in the lamp vessel wall opposite one another in pinched seals 10, 11 from which also the internal current conductors enter the interior opposite one another. The lamp vessel 1 is fixed in a lamp cap 12 which has contacts 13, 14. The lamp consumes a power of approximately 45 W at 12 V during operation and is suitable for use in an optical system, for example, as a vehicle headlamp or an image projector.

1. A lamp comprising a lamp vessel (1) of quartz glass and having a room filled with gas, two electrodes (5) extending into said room, two external current conductors (6) partially extending outside said vessel (1), two metal foils (4) embedded in said quartz glass, wherein a first end portion of a metal foil (4) is connected to an electrode (5) and wherein a second end portion of said metal foil (4) is connected to an external current conductor (6), characterized in that an end portion (8) of said external conductor (6) which is connected to said metal foil (4) has a substantially circular cross section having a surface area which is smaller than the cross section of the portion of said external current conductor (6) extending outside the vessel (1).

2. A lamp according to claim 1, wherein the surface area of the cross section of said end portion (8) of the external current conductor (6) is equal to or less than 0.80 times, preferably equal to or less than 0.50 times, more preferably equal to or less than 0.33 times the surface area of the cross section of said portion of the external current conductor (6) extending outside the vessel (1).

3. A lamp according to claim 1, wherein the surface area of the cross section of said end portion (8) of the external current conductor (6) is less than 0.7 mm, preferably equal to or less than 0.5 mm, more preferably equal to or less than 0.4 mm.

4. A lamp according to claim 1, wherein the length of the end portion (8) having a reduced cross section is at least 2 mm, preferably at least 4 mm.

5. A lamp according to claim 1, wherein the metal foils (4) and/or the external current conductors (6) are substantially made of molybdenum.

6. A lamp according to claim 1, wherein the metal foil (4) is provided with a chrome coating in the area surrounding the connection with the external current conductors (6).

7. Method for producing a lamp, wherein two electrodes (5) are connected to two external current conductors (6) by means of a metal foil (4), wherein a first end portion of said metal foil (4) is connected to an electrode (5) and wherein a second end portion of said metal foil (4) is connected to an end portion of an external current conductor (6), wherein a vessel (1) is made of quartz glass such that a room is formed which is filled with a gas, wherein said metal foils (4) are embedded in said quartz glass, wherein said electrodes (5) are extending into said room, and said external current conductors (6) are partially extending outside said vessel (1), characterized in that said end portion (8) of said external current conductor (6) destined to be connected to said metal foil (4) is provided with a substantially circular cross section having a surface area which is smaller than the cross section of the portion of the external current conductor (6) destined to extend ouside the vessel (1).
